(19) United States
(12) Patent Application Publication
(10) Pub. No.: US 2005/0273359 A1
(43) Pub. Date: Dec. 8, 2005

(54) System and method of evaluating preoperative medical care and determining recommended tests based on patient health history and medical condition and nature of surgical procedure

(76) Inventor: David E. Young, Chicago, IL (US)

Correspondence Address: QUARLES & BRADY LLP, RENAISSANCE ONE, TWO NORTH CENTRAL AVENUE, PHOENIX, AZ, 85004-2391, US

(21) Appl. No.: 10/861,877

(22) Filed: Jun. 3, 2004

(51) Int. Cl. G06F 17/60

(52) U.S. Cl. 705/2

(57) ABSTRACT

A health care screening system obtains patient health history and analyzes data to determine recommended preoperative medical testing. The patient's medical condition are obtained through patient responses to a questionnaire. The surgical procedure is provided by a physician. A first evaluation table of surgical procedures and corresponding preoperative medical tests is generated. A second evaluation table of patient medical condition and corresponding preoperative medical tests is generated. A third evaluation table of surgical procedures and corresponding patient medical condition is generated. The recommended preoperative medical testing and/or algorithms as indicated from the evaluation tables is scheduled. The recommended preoperative medical testing is maintained in a database, which is updated with changes to preoperative medical testing guidelines and is configurable for each medical institution. Preoperative reports are generated for medical staff and the patient based on the evaluation tables.

### FIELD OF THE INVENTION

The present invention relates in general to medical testing and, more particularly, to system and method of evaluating preoperative medical care and determining recommended tests based on patient health history and medical condition and nature of surgical procedure.

### BACKGROUND OF THE INVENTION

Health care providers continuously face high expectations, rising costs, mounting competition, legal pressures, and government regulation. To remain profitable, health care facilities must operate at high efficiency, as there is precious little room for downtime or error recovery. Hospital administration, physicians, nurses, technicians, and support staff all share responsibility for the well-being of the patient and profitability of the institution.

The operating room is one area of the health care facility which must run at peak efficiency. There are significant costs associated with maintaining an operating room, e.g., equipment, staff, compliance, and insurance. The operating room must be kept busy to generate revenue and distribute the costs in a profitable manner.

Patients are scheduled into the operating room for specific times. The entire operating room staff, including the surgeon, anesthesiologist, nurses, and other specialists and technicians must be present before the procedure can begin. Yet each of these people typically operate on tight schedules seeing patients, performing other procedures, and attending meetings, and many times do not have the flexibility to change their schedule. If the patient's surgical procedure cannot be performed at the appointed time, then the operating room may sit idle, which costs everyone time and money. When a delay or cancellation occurs, that means the operating room is not being billed out, the medical staff is not working, and the patient may not be getting a needed procedure.

One of the more common reasons for cancellations or delayed surgical procedures is the realization of some previously unknown or unrecognized health history and medical condition of the patient, just prior to surgery, which may complicate or increase the risk of the procedure to the patient. When the potential risk of the procedure outweighs the immediate benefit to the patient, then the procedure should be cancelled or delayed until such time as the risk can be understood and quantified. Preoperative laboratory and physical testing is a primary analysis tool to understanding the patient's medical condition and accessing the risk of the surgery.

There exist a number of preoperative tests to minimize or at least quantify the risk to the patient. Each health care facility may have its own guidelines and rules regarding preoperative testing. Given certain patient information, the health care provider may want certain testing to be done. Based on the test results, the patient can be better prepared and monitored during the procedure. Failure to perform one or more preoperative tests can lead to last-minute cancellation or delay of the procedure, which, as discussed, is an undesirable result for everyone concerned.

Thus, it is important to know the patient's medical condition and history before the surgery is scheduled and confirmed. One approach for preoperative patient screening is to conduct preop clinics in which every preop patient comes into the clinic, for example, a week before surgery. The patient sees a physician or other health care provider for a routine preop screening, which involves checking the patient's vital signs including blood pressure, pulse, oximetry reading, etc., and reviewing the patient's history and physical examination. If the findings indicate a concern or health problem area, further preop tests can be scheduled. Unfortunately, no reimbursement is available from insurance for preop clinics, and the extra trip to the hospital is inconvenient for the patient. Very few institutions can afford to run preop clinics on a regular basis.

Another preop screening approach involves using the medical staff, e.g., nurses or technicians, to call the patient by phone and get a medical history prior to surgery. The screening process is costly, again with no reimbursement from insurance. Since the patient is not physically being seen, the phone screening provides only superficial or limited information. There may be language difficulties during the phone interview; many questions may remain unanswered.

A third approach involves having the patient arrive early on the day of surgery to complete a health questionnaire designed to screen for medical issues that may be relevant to the procedure to be performed, and may require the patient to undergo further testing. If it is determined that additional testing is necessary based on the patient's responses on the questionnaire, then the appropriate tests are scheduled. The operating room staff has little leeway in waiving any further testing which has been indicated by the questionnaire. In most cases, if the appropriate preoperative tests have not been completed, or if the results have been deemed unsatisfactory, the surgery is cancelled or delayed, and the operating room sits empty.

A fourth approach that has been used with some success involves the patient completing a health care questionnaire while in their primary care physician's office or surgeon's office prior to surgery. The questionnaire is completed using a computer system. The patient answers basic questions on the computer screen regarding health related areas such as past medical problems, coronary artery disease, cardiovascular disease, valvular heart disease, pulmonary disease, renal disease, liver disease, smoking history, alcohol history, and the like. Many of the questions are given in yes/no answer format. A “yes” answer to a question such as, “Do you have high blood pressure?” will bring up follow-on questions. A “no” answer moves to the next major health category. The answers are sent over the Internet link to a central server, typically located in the hospital. An analysis is performed on the completed questionnaire and the answers to the patient-friendly questions are converted to a report meaningful to the health care provider. Although computer-based pre-screening analysis is not cheap, the reduced incidence of operating room cancellations helps offset the costs.

Unfortunately, the computer-based questionnaire does not necessarily answer all the questions or preempt all unforeseen need for more complete preoperative testing. The report, in and of itself, does not cause any particular preoperative test to be recommended or scheduled. Instead, the report just provides a synopsis of the patient's answers to the questionnaire. The medical staff must still decide what preop testing should be done under the circumstances. The person evaluating the report may not know the preop testing guidelines of the hospital. The evaluator may overlook or fail to consider the current best medical practices for a given patient's health history and medical conditions. In some cases, the patient may still arrive for surgery without certain necessary testing, as determined by the surgeon or anesthesiologist, being performed, thereby causing the surgery to be cancelled or delayed.

A need exists to achieve greater assurance that the necessary preoperative testing and preparation has been done before the scheduled surgery.

### SUMMARY OF THE INVENTION

In one embodiment, the present invention is a method of determining recommended preoperative medical testing comprising recording patient medical condition, recording a surgical procedure to be performed, providing a first evaluation table of surgical procedures and corresponding preoperative medical testing, providing a second evaluation table of patient medical condition and corresponding preoperative medical testing, and determining the recommended preoperative medical testing as indicated from the first and second evaluation tables.

In another embodiment, the present invention is a method of providing for determining a preoperative medical testing comprising providing a first evaluation table of surgical procedures and corresponding preoperative medical testing, providing a second evaluation table of patient medical condition and corresponding preoperative medical testing, and determining preoperative medical testing as indicated by the first or second evaluation tables.

In yet another embodiment, the present invention is a method of evaluating preoperative medical care comprising providing a record of surgical procedure and patient medical condition, and providing for preoperative medical testing with consideration of the surgical procedure or patient medical condition.

In still another embodiment, the present invention is a method of providing for preoperative medical care comprising relating surgical procedure to preoperative medical testing, relating patient medical condition to preoperative medical testing, and selecting preoperative medical testing based on the surgical procedure or patient medical condition.

### BRIEF DESCRIPTION OF THE DRAWINGS

FIG. 1 is a block diagram illustrating the health care screening system;

FIG. 2 illustrates the communication network connecting patient and physician to health care provider and health care screening database;

FIG. 3 illustrates a first webpage for physician data entry to generate the patient questionnaire;

FIG. 4 illustrates a second webpage for patient data entry into the questionnaire;

FIG. 5 illustrates a third webpage for patient data entry into the questionnaire;

FIG. 6 illustrates a first evaluation table relating a first set of surgical procedures to preoperative laboratory and physical testing;

FIG. 7 illustrates a second evaluation table relating a second set of surgical procedures to preoperative laboratory and physical testing;

FIG. 8 illustrates a third evaluation table relating patient medical conditions to preoperative laboratory and physical testing;

FIG. 9 illustrates a fourth evaluation table relating the first set of surgical procedures to patient medical condition;

FIG. 10 illustrates a fifth evaluation table relating the second set of surgical procedures to patient medical condition;

FIG. 11 illustrates a cardiac assessment algorithm; and

FIG. 12 illustrates the process of evaluating and determining recommended preoperative medical tests.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

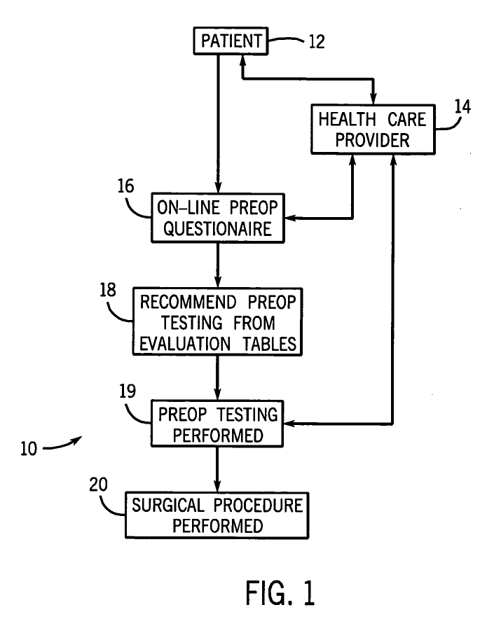

A health screening system 10 is shown in FIG. 1. Patient 12 receives health care from hospital, clinic, or health care provider 14. Health care provider 14 may be a private physician, medical practice group, health maintenance organization (HMO), hospital, clinic, or other provider of medical care and services. The primary care physician provides most if not all forms of health care for patient 12. Health care provider 14 routinely performs history, physical, and other tests on patient 12, and may detect or diagnose certain conditions, ailments, or diseases. In some situations, patient 12 may require a surgical procedure to resolve the medical problem.

Any surgical procedure inherently contains an element of risk for patient 12. The patient is anesthetized and the body is at least partially opened to allow the surgical work to be done, which is always a serious matter. Patient 12 may have physical or psychological conditions that increase the risk of the procedure. In any case, it is important to know the complete physiological state of patient 12 in order that the patient is properly prepared, precautions put in place, and extra steps taken, as necessary to minimize the risk to the patient and achieve a successful result. The surgical staff needs to know the medical condition and health history of patient 12 in case complications arise during the surgery or postoperatively. For example, the surgical team should know before the operation that patient 12 has hypertension, asthma, emphysema, congestive heart failure, diabetes, hemophilia, or takes prescription medications. The present quantitative and objective state of these conditions should be made known before the surgery is scheduled and confirmed.

There exist a number of preoperative laboratory and physical tests that can be performed to quantify and fully understand the state of any patient's medical condition that would be relevant to the surgical procedure to be performed. The preop test results would not necessarily negate the surgery, which is presumed to be necessary in its own right, but rather would inform the surgical staff so that precautions could be taken and adverse reactions or complications handled in an effective and safe manner to reduce the risk of the procedure to the patient.

Health care provider 14 has established preoperative testing procedures and guidelines, which must be followed in its facilities. The preop guidelines may differ between health care facilities, depending on the resources of the facility, administrative policy, and physician recommendations. Health care provider 14 has an obligation to avoid unnecessary risk to patient 12 and a business interest in making efficient use of the operating room and other resources. The preop testing serves the best interests of patient 12 by providing important test results which document their physiological condition, and provides for efficient use of the operating room resources by avoiding unnecessary cancellations.

In most cases, the physical and psychological condition of patient 12 should be evaluated and preoperative testing should be considered. Some patients have no knowledge or external manifestation of any short-term or long-term medical condition, i.e., they are in a good state of health, aside from the present surgical need. Examples may be an amateur athlete with a sports injury requiring surgery to repair, or an otherwise healthy adult having cosmetic surgery. A preoperative evaluation may conclude that there is little or no need for special preop laboratory and physical testing, or at least that a reduced testing schedule is indicated.

Other patients have chronic health problems such as hypertension, emphysema, heart disease, or diabetes. A preoperative evaluation should reveal or confirm these conditions. Preoperative laboratory and physical testing will likely be required by health care provider 14, depending on the surgical procedure to be performed. Preoperative testing may involve one or more of the following tests: chest x-ray (CXR); complete blood count (CBC); electrocardiogram (EKG); blood chemistry such as potassium, sodium, bicarbonate, glucose, blood urea nitrogen (BUN), creatinine, calcium, bilirubin, and alkaline phosphatase; type and screen blood; type and cross blood; prothrombin time/partial thrombin time (PT/PTT); international normalized reagent (INR); pulmonary function; pregnancy test; and more.

The surgical team has little leeway in waiving the preop testing requirements as set by health care provider 14. One exception may be emergency surgery in life-threatening situations. In another situation, where the surgery is urgent but not life-threatening, the health care provider may consider prior medical information regarding patient 12, say less than 5 years old, as sufficient to perform the urgent surgical procedure.

When a surgical procedure is indicated, as determined by health care provider 14 in consultation with patient 12, a preoperative evaluation is conducted. The preoperative evaluation is a screening process and takes the form of a questionnaire, or question and answer session, in which patient 12 participates by answering a series of questions. In one embodiment, the preop evaluation is conducted with on-line preop questionnaire 16 using a computer system with Internet connection. Patient 12 can complete the on-line preop questionnaire 16 while visiting health care provider 14, in their primary care physician's office, in the surgeon's office, in the privacy of their own home, or anywhere there is an Internet connection. Patient 12 simply logs into a website, enters certain identification information, steps through the screens, and answers the questions. Patient 12 may receive assistance from the medical staff if he or she needs help. When complete, the answers are sent to health care provider 14, or a service utilized by health care provider 14, to evaluate the questionnaire.

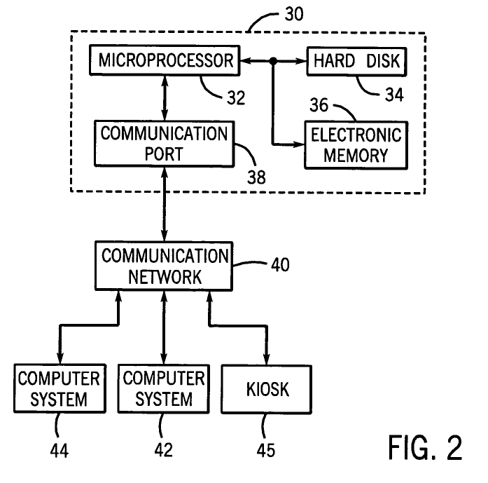

Further details of the Internet-based computer system is shown in FIG. 2. Computer system 30 is provided to host and access an Internet-based website. Computer system 30 is a general purpose computer including a central processing unit or microprocessor 32, mass storage device or hard disk 34, electronic memory 36, and communication port 38. Communication port 38 may be a high-speed Ethernet connection to communication network 40. Communication network 40 is an open architecture system such as the World Wide Web, commonly known as the Internet. Computer systems 42 and 44 are configured as shown for computer 30 and are also connected to communication network 40. Kiosk 45 is a dedicated and secure data entry terminal connected to communication network 40.

Computers 30, 42, and 44, and kiosk 45, can be physically located in any location with access to a modem or communication link to network 40. For example, computer 30 can be a central server at the health care provider's home office. Computer 42 can be located in the physician office, surgeon's office, hospital's patient screening area, or patient's home, just to name a few. Computer 44 is located in the health care facility to give general access to the medical staff.

Computer 30 runs application software and computer programs, which can be used to host one or more websites. The software is originally provided on computer readable media, such as compact disks (CDs), or downloaded from a vendor website, and installed on computer 30. Each website hosted on computer 30 includes one or more webpages for viewing information and for receiving information from patient 12 and health care provider 14. In the present discussion, a preoperative screening website is set-up and maintained on computer 30. Patient 12 accesses the preoperative screening website using computer system 42. The information displayed on the website is generally stored in a database on hard disk 34, or other mass storage device accessible to computer 30. The database is used to store and maintain the questionnaires and corresponding answers which pass through the website. Users operating from systems 42-45 from any location can, via communication network 40, log into the website hosted by computer 30 to view information and enter information via the website.

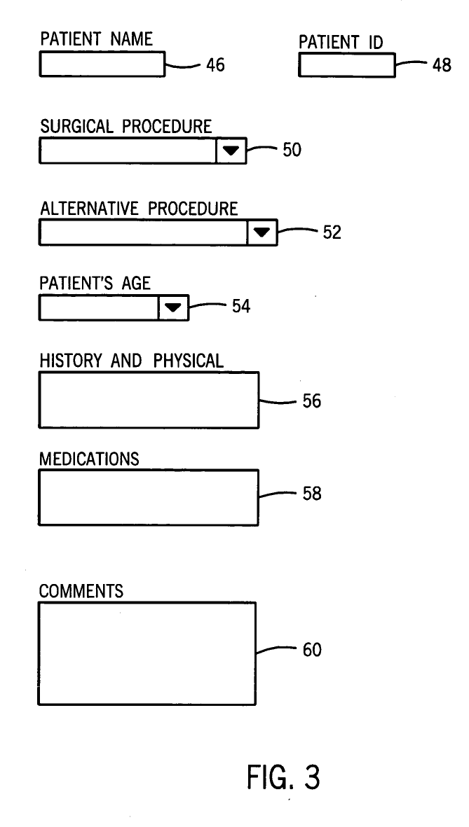

FIGS. 3-5 illustrate a few of the types of selections and information that can be made available on the preop screening website. An actual commercial website will include more in the way of graphics, drawings, text, instructions, marketing, color, and appeal. The hierarchical structure of the preop screening website is organized by design choice. The organization and design of the website can take many forms and hierarchical structures. Some website designs pack as much information and as many hyperlinks as possible into the first webpage. Other website designs have a first webpage that is clean and simple and count on the user providing some preliminary information before moving to lower level webpages.

Assume health care provider 14 determines that patient 12 needs a particular surgical procedure. Health care provider 14, or the patient's physician or surgeon, logs into the preop screening website and sets up a questionnaire for patient 12. Health care provider 14 uses computer 44 to access the website on computer 30 to schedule the questionnaire. The questionnaire scheduling screen is shown in FIG. 3. The physician or surgeon, or their assistant, will enter the patient's name in box 46; patient identification number in box 48; primary surgical procedure to be performed in box 50; alternative procedures that may need to be performed depending on the outcome or findings of the primary procedure in box 52; age of the patient in box 54; history and physical, including health history and medical conditions of patient 12 as determined from the physical examination, in box 56; medications being taken by or prescribed for patient 12 in box 58; and other comments from the physician which may be relevant to surgical procedure(s) in box 60. Boxes 50-54 are shown with pull-down menu selections or screens of known or pre-assigned values. The pull-down screens reduce data entry errors and increase the consistency of answers from health care provider 14.

The questionnaire will have a number of general questions and a number of specific questions related to the given surgical procedure(s). The computer program running on computer 30 formulates either a standard or semi-custom questionnaire for patient 12 based on the information entered by the physician or surgeon. The semi-custom questionnaire is generated with consideration of the surgical procedure(s) to be performed and the known health history and medical condition(s) of patient 12. A library of questions is maintained on hard disk 34 and compiled by the software running on computer 30. The software generates a patient preop identification number, which is given to patient 12. The preop identification number may be randomly or sequentially generated, or based on patient information such as social security number or patient identification number assigned by the hospital.

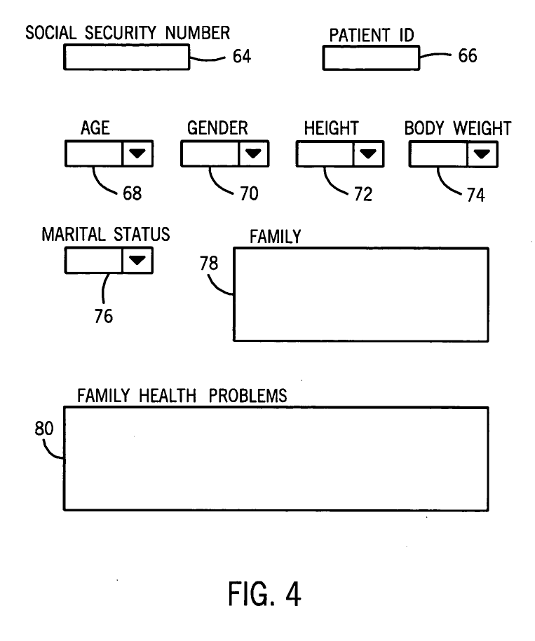

From the physician's office or surgeon's office, or from home, patient 12 logs into the preop screening website to complete the preop screening questionnaire. Patient 12, using computer 42, enters the uniform resource locator (URL) address for the preop screening website on computer 30. In an alternate embodiment, patient 12 uses a dedicated data entry terminal, e.g., kiosk 45, which is connected by a dedicated and secure communication link for privacy and security through network 40 to the preop screening website on computer 30. Patient 12 enters the preop identification number. The website retrieves the pre-generated on-line questionnaire for patient 12 from hard disk 34, based on preop identification number, and displays the first screen of questions on computer 42, such as shown in FIG. 4.

The questions are organized in a hierarchical manner, for example, using branching chain logic, to simplify the on-line questionnaire for patient 12. The first series of questions inquire as to personal and family history. Patient 12 enters his or her name or social security number in box 64, patient identification number in box 66, age in box 68, gender in box 70, height in box 72, body weight in box 74, marital status in box 76, family information (spouse, children, parents, and siblings) in box 78, and family health problems in box 80. Boxes 68-76 are shown with pull-down menu selections or screens of known or pre-assigned values.

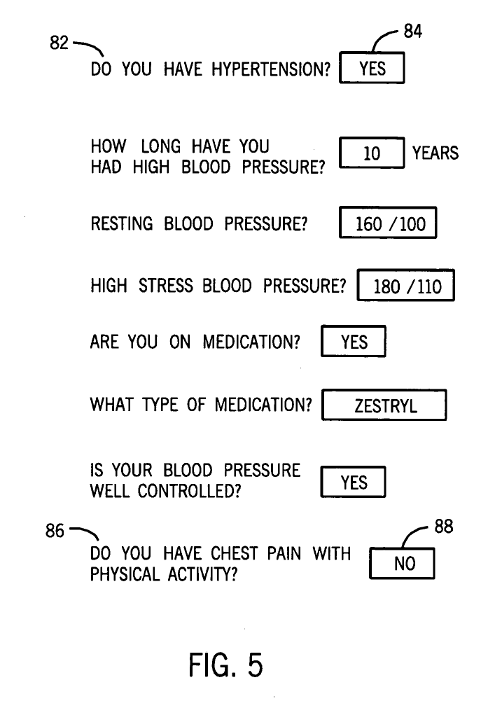

The questionnaire then inquires as to specific health concerns. In FIG. 5, question 82 may ask patient 12 if he or she has hypertension. If patient 12 answers “yes” in box 84, then additional or follow-on questions are asked to quantify and explore the state and nature of that medical condition. Follow-on questions may include areas such as “How long have you had high blood pressure?”, “What is your resting blood pressure?”, “What is your high stress blood pressure?”, “Are you on medication?”, “What type of medication are your taking?”, “Is your blood pressure well controlled”, and so on. Patient 12 answers each follow-on question.

If patient 12 answers “no” in box 84, then no further questions related to hypertension are presented. The questionnaire skips to the next major topic question 86, e.g., “Do you have chest pain with physical activity?”, or “Are you diabetic?” Patient 12 answers question 86 in box 88.

The major areas of preoperative patient inquiry are typically outwardly symptomatic or known to patient 12 from prior diagnosis and treatment. The questions are written in a simple format and manner, which is readily understandable to the vast majority of adults. The major health-related areas may inquiry as to headaches, vision, shortness of breath, weakness, dizziness, earaches, stroke, trouble swallowing, excessive coughing, coughing up blood, blood in stool, diarrhea, pain during urination, excessive gastrointestinal pain, chest pain, trouble breathing, heart disease, dentures, diabetes, cancer, depression, trouble sleeping, irregular menstrual periods, swelling in extremities, smoking history, alcohol consumption, recreational drug use, prescribed medications, prior surgeries, just to name a few. Other major areas of health inquiry and questions are generally known in the medical community and may be organized in bodily systemic manner, e.g. head to foot. Each major health-related area may present follow-on questions to extract further information from patient 12.

The answer format may be true/false, yes/no, fill-in the blank, multiple choice, check one or more boxes next to given answer choices, etc. The branching chain logic or other organizational structure minimizes the number of questions, avoids unnecessary questions, and expands on the more relevant questions.

Patient 12 answers all questions on the preop screening questionnaire. The answers are stored in the database on hard disk 34. The software can perform certain error checking and confidence level analysis while processing the patient's answers. If patient 12 answered that he or she experiences hypertension and yet entered normal or low blood pressure on the follow-on questions, then the software flags the answer as suspect. The on-line questionnaire may not accept the patient's answer as being inconsistent with prior answers, or the medical staff may need to follow up with patient 12 to clarify or explain the answer. Alternatively, if patient 12 answered “no” to hypertension in box 84, but the physician had measured high blood pressure during the physical exam, then the on-line questionnaire will make further inquiry, or the patient's answer is reviewed or re-confirmed. The patient questionnaire is repeated if necessary to get a set of answers that are consistent and reliable.

In some situations, a medial staff member will assist patient 12 in completing the preop screening questionnaire. The assistance may be necessary for elderly patients, handicapped patients, patients who are not computer literate, or patients who otherwise need extra help. The medical staff may also need to assist if patient 12 has difficulty compiling a set of answers that is consistent and reliable in view of their known or perceived physical ability and history.

Once the questionnaire is complete, the software on computer 30 accesses one or more preoperative evaluation tables, which have been pre-compiled based in part on medical specialty, e.g. gynecology or general surgery, possible patient medical conditions, and available preoperative testing. Health care provider 14 generates the evaluation tables based on best medical practices, available resources, internal policy, and risk assessment. The preoperative evaluation tables reside in the database on hard disk 34. The evaluation tables come in multiple parts and relate (1) surgical procedures, in degrees of invasiveness, to laboratory and physical testing, (2) patient medical conditions to laboratory and physical testing, and (3) surgical procedures, in degrees of invasiveness, to patient medical conditions. The evaluation tables provide an objective, reliable, and consistent way of establishing which preop tests are recommended and should be performed, according to the best available medical practices and doctrine, and guidelines and policies as established by health care provider 14.

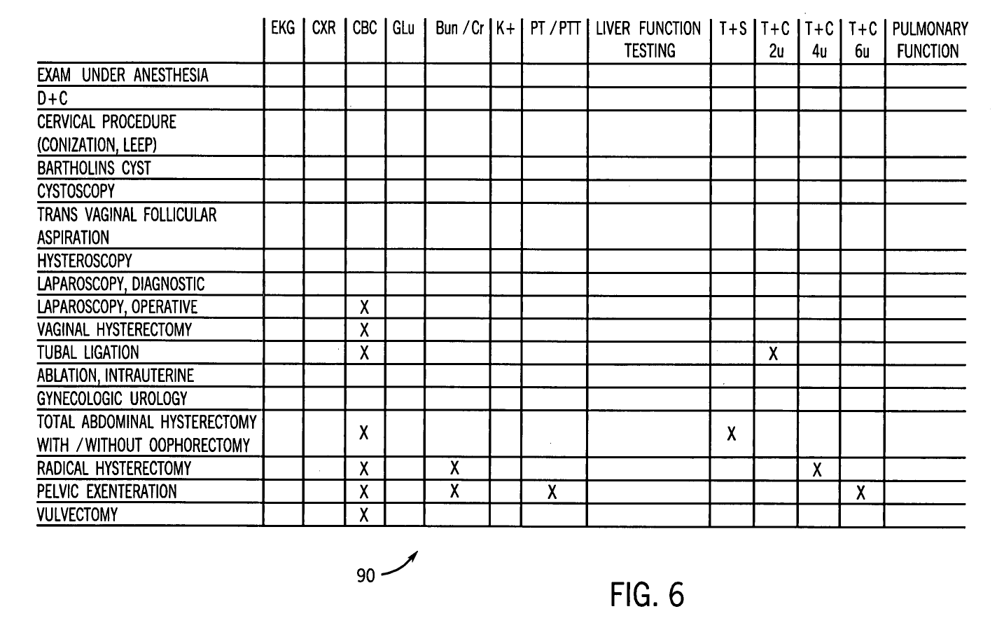

Evaluation table 90, as shown in FIG. 6, relates surgical procedures, in degree of invasiveness, to preoperative laboratory and physical testing. Each surgical procedure as shown along the y-axis with increasing levels of invasiveness. For example, in the general area of gynecology, from the least to the most invasive, the procedures are: exam under anesthesia, dilatation and curettage (D&C), cervical procedure (conization, LEEP), Bartholin's cyst, cystoscopy, transvaginal follicular aspiration, hysteroscopy, diagnostic laparoscopy, operative laparoscopy, vaginal hysterectomy, tubal ligation, intrauterine ablation, gynecologic urology, total abdominal hysterectomy with and without oophorectomy, radical hysterectomy, pelvic exenteration, and vulvectomy. The procedures may be further grouped by risk to the patient, e.g., Group I being minor procedures, Group II being major procedures, and Group III being potentially life-threatening situations. Group I includes procedures such as exam under anesthesia, D&C, cervical procedure. Group II includes procedures such as vaginal hysterectomy, tubal ligation, and intrauterine ablation. Group III includes procedures such as radical hysterectomy, pelvic exenteration, and vulvectomy. Along the x-axis, the various laboratory and physical tests are given as: EKG, CXR, CBC, glucose, BUN/creatinine, potassium, PT/PTT, liver function, type and screen blood, type and cross 2 units blood, type and cross 4 units blood, type and cross 6 units blood, and pulmonary function.

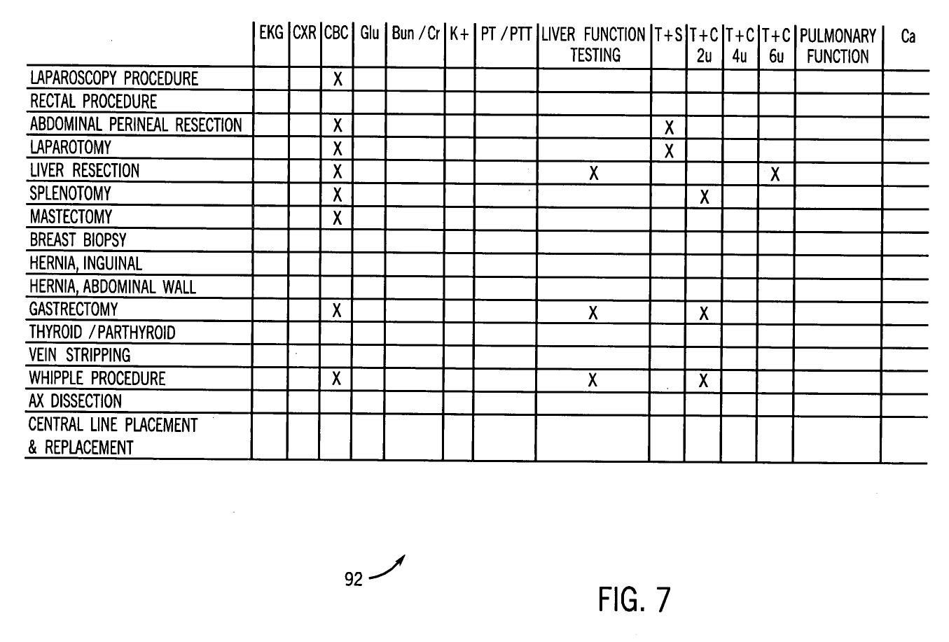

Another evaluation table 92 is shown in FIG. 7 relating general surgery procedures to preoperative laboratory and physical testing. In the general surgery area, the procedures are: laparoscopy, rectal procedure, abdominal perineal resection, laparotomy, liver resection, splenotomy, mastectomy, breast biopsy, inguinal hernia, abdominal wall hernia, gastrectomy, thyroid/parathyroid, vein stripping, Whipple procedure, axillary dissection, and central line placement and replacement. Along the x-axis, the various laboratory and physical tests are given as: EKG, CXR, CBC, glucose, BUN/creatinine, potassium, PT/PTT, liver function, type and screen blood, type and cross blood 2 units, type and cross 4 units, type and cross 6 units, pulmonary function, and calcium.

The relevant surgical procedure information for the subject patient comes from the physician and/or surgeon data entry in boxes 50-52 as shown in FIG. 3. From the list of possible procedures in evaluation tables 90-92, the tables show which laboratory and physical tests are recommended and should be performed, as indicated by an “X” in the grid, for the specific procedure(s) to be performed on patient 12, according to the policies and guidelines of health care provider 14.

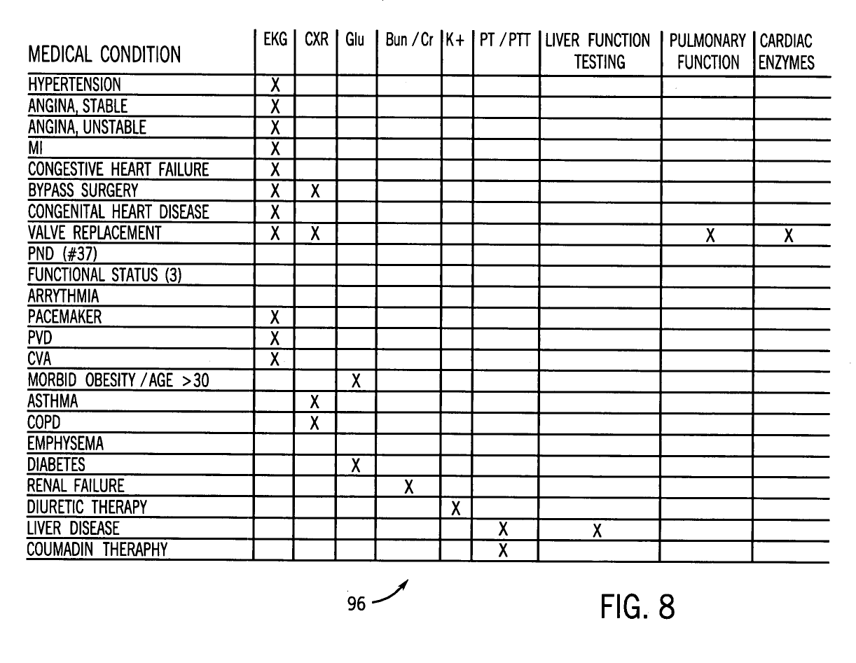

In FIG. 8, evaluation table 96 relates patient medical condition to preoperative laboratory and physical testing. The patient's medical condition includes prior health history and present state of health. Each patient health history and present medical condition is shown along the y-axis as: hypertension, angina stable, angina unstable, myocardial infarction (MI), congestive heart failure, bypass surgery, congenital hear disease, vascular replacement, paroxysmal nocturnal dyspnea (PND), functional status, arrhythmia, pacemaker, peripheral vascular disease (PVD), cerebrovascular accident (CVA), obesity, asthma, chronic obstructive pulmonary disease (COPD), emphysema, diabetes, renal failure, diuretic therapy, liver disease, and coumadin therapy. Along the x-axis, the various laboratory and physical tests are given as: EKG, CXR, glucose, BUN/creatinine, potassium, PT/PTT, liver function, pulmonary function, and cardiac enzymes.

The patient's medical conditions can be derived from the evaluation of the patient questionnaire as provided in FIGS. 4 and 5, and from prior medical records. From the list of possible medical conditions in evaluation table 96, the table shows which laboratory and physical tests are recommended and should be performed, as indicated by an “X” in the grid, for the specific medical condition(s) attributed to patient 12, according to the policies and guidelines of health care provider 14.

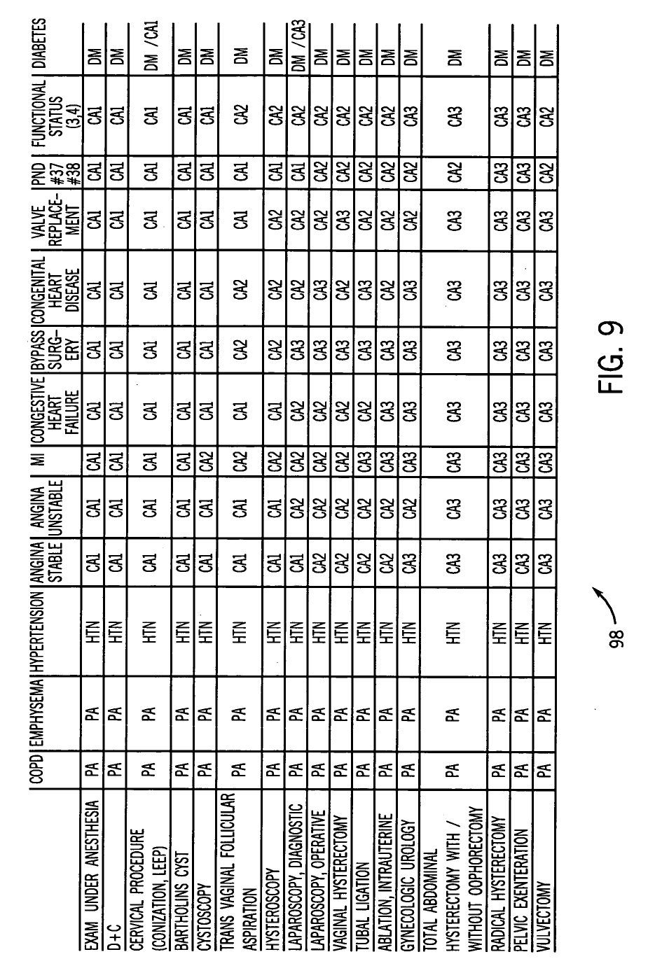

Yet another evaluation table 98, as shown in FIG. 9, relates gynecologic surgical procedure, in degrees of invasiveness, to patient medical conditions. Each surgical procedure as shown along the y-axis with increasing levels of invasiveness. Again, the procedures are: exam under anesthesia, D&C, cervical procedure (conization, LEEP), Bartholin's cyst, cystoscopy, transvaginal follicular aspiration, hysteroscopy, diagnostic laparoscopy, operative laparoscopy, vaginal hysterectomy, tubal ligation, intrauterine ablation, gynecologic urology, total abdominal hysterectomy with and without oophorectomy, radical hysterectomy, pelvic exenteration, and vulvectomy. Each patient medical condition is shown along the x-axis as: COPD, emphysema, hypertension, angina stable, angina unstable, MI, congestive heart failure, bypass surgery, congenital heart disease, valve replacement, PND, functional status, and diabetes.

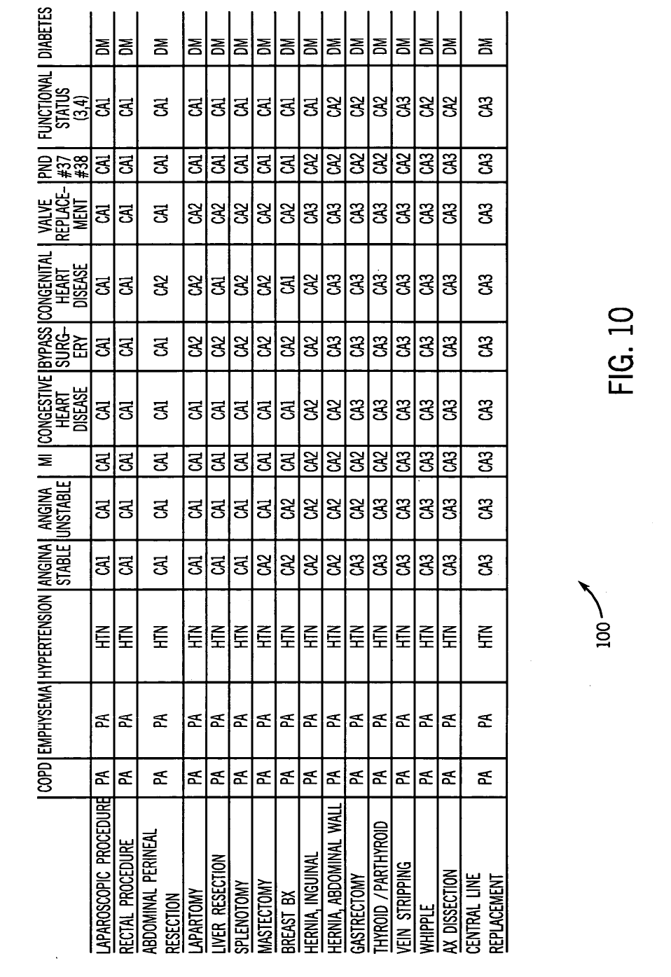

In FIG. 10, evaluation table 100 also relates surgical procedure to patient medical conditions. In the general surgery area, the surgical procedures are: laparoscopy procedure, rectal procedure, abdominal perineal resection, laparotomy, liver resection, splenotomy, mastectomy, breast biopsy, inguinal hernia, abdominal wall hernia, gastrectomy, thyroid/parathyroid, vein stripping, Whipple procedure, axillary dissection, and central line replacement. Along the x-axis, the patient medical conditions are given as: COPD, emphysema, hypertension, angina stable, angina unstable, MI, congestive heart failure, bypass surgery, congenital heart disease, valve replacement, PND, functional status, and diabetes.

Again, the relevant surgical procedure information for the subject patient comes from the physician and/or surgeon data entry in boxes 50-52 as shown in FIG. 3, and the patient's medical conditions can be derived from the evaluation of the patient questionnaire as provided in FIGS. 4 and 5, and from prior medical records. From the possible medical conditions, for each surgical procedure, evaluation tables 98 and 100 show specific testing algorithms that are recommended and should be performed prior to surgery, according to the policies and guidelines of health care provider 14.

A testing algorithm is a multi-step process, provided in a decision-tree format, in which a series of evaluations, analysis, and tests are performed to determine whether further laboratory and physical testing is indicated or recommended. It does not necessary lead to further preoperative laboratory testing, but rather is a more elaborate analysis than described for evaluation tables 90-96. The testing algorithm may involve preparatory steps, evaluations based on patient questionnaire and other information, testing, diet, medications, actions, or avoidance of actions, which are performed under given conditions, in a predetermined order, with alternate paths depending on the step-by-step analysis. The testing algorithm may be simple or complex and involve a series of steps and decision branches based on test results and known medical conditions. The testing algorithms are developed and based on evasiveness of the surgical procedure to be performed. The number of testing algorithms and format of each testing algorithm is established by health care provider 14, in consultation with its medical staff.

In evaluation tables 98 and 100, the testing algorithms are Pulmonary Assessment Algorithm (PA), Hypertension Algorithm (HTN), Cardiac Assessment Algorithm for minimally invasive surgery (CA1), Cardiac Assessment Algorithm for moderately invasive surgery (CA2), Cardiac Assessment Algorithm for highly invasive surgery (CA3), and Diabetes Mellitus Algorithm (DM). Note that more than one algorithm may be defined per grid entry. In addition, one algorithm may link to or invoke another algorithm.

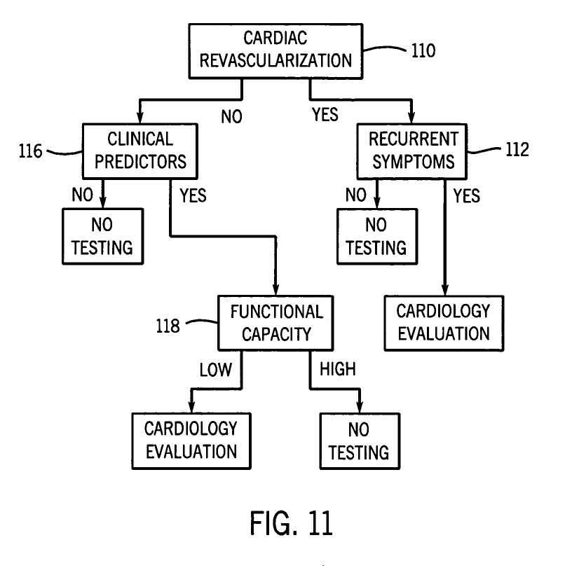

By way of example, the Cardiac Assessment Algorithms are defined in three levels, i.e. CA1, CA2, and CA3, as related to the evasiveness of the procedures. Again, the process for each of these algorithms will be established by health care provider 14. Further details of CA3 are shown in FIG. 11 using a simplified decision-tree format. Block 110 considers whether patient 12 has had cardiac revascularization in the past 5 years. If block 110 is yes, then block 112 considers whether patient 12 is having recurrent symptoms. If block 112 is yes, then block 114 recommends a cardiology evaluation, including EGK and cardiac enzymes, according to the CA3 algorithm. If block 112 is no, then no further testing is recommended. If block 110 is no, then block 116 considers major, intermediate, and minor clinical predictors. Major clinical predictors include unstable coronary syndrome, unstable angina, and severe vascular disease; intermediate clinical predictors include diabetes mellitus, renal insufficiency, and prior heart failure; and minor clinical predictors include age greater than 75 years, history of stroke, and abnormal EGK. If block 116 finds no clinical predictors, then no further testing is recommended. If block 116 yields one or more positive clinical predictors, then the functional capacity of patient 12 is considered. In block 118, functional capacity is considered in terms of metabolic equivalents (METS) score. A low METS score, e.g. <4, results in a recommendation for cardiology evaluation based on risk of procedure. A high METS score, e.g. >4, results in no further testing.

The above simplified Cardiac Assessment

Algorithm is given by way of example. Other cardiac assessment algorithms are known in the art and may have more or less evaluation and analysis, and testing depending on the internal procedures and policy of health care provider 14. The PA, HTN, and DM algorithms are also established by health care provider 14 using standard medical guidelines.

The software running on computer 30 will have compiled the evaluation tables 90-100 from best medical practices and doctrine, as determined by health care provider 14, for all surgical procedures and medical conditions, for the available preoperative laboratory and physical tests, all of which have been stored in the database on hard drive 34. For each evaluation table, an “X” or other marker or information is placed within the grid to represent the relationship between the axis. For example, evaluation table 90 illustrates that for a total abdominal hysterectomy, CBC and type and screen are recommended. Also from evaluation table 90, CBC, BUN/creatinine, PT/PTT, and type and cross 6 units are recommended for a pelvic exenteration. In the general surgery field, evaluation table 92 illustrates that for a laparoscopy procedure, CBC is recommended; and for a Whipple procedure, CBC, liver function testing, and type and cross 2 units blood are recommended.

Evaluation table 96 illustrates an “X” where the test is indicated or recommended for the corresponding patient medical condition. EKG is recommended when the patent has hypertension. EKG, CXR, pulmonary function, and cardiac enzymes are recommended when the patient has had a valve replacement.

In evaluation tables 90-96, a blank indicates that no test is indicated or recommended. In evaluation table 90, no tests are recommended for exam under anesthesia. In evaluation table 92, no tests are recommended for breast biopsy. In evaluation table 96, no test, other than EKG, is recommended for angina stable. A determination of no testing recommendation is just as useful and important as determination that testing should be done. Unnecessary testing, in view of accepted best medical practice guidelines, wastes time and money and puts patient 12 through unnecessary processes. Health care provider 14 establishes the tests recommended for the procedure and patient's medical condition. Another health care provider may recommend more or less testing than is shown in evaluation tables 90-96.

Evaluation table 98 shows a number of testing algorithms in the grid, e.g. PA algorithm is shown between COPD and exam under anesthesia. Accordingly, the PA algorithm is recommended for a patient that has COPD and is undergoing an exam under anesthesia. HTN algorithm is shown between hypertension and D+C. HTN algorithm is recommended for a patient that has hypertension and is undergoing D+C. CA3 algorithm is shown between angina stable and radical hysterectomy. CA3 algorithm is recommended for a patient with angina stable and is undergoing radical hysterectomy. CA2 algorithm is shown between congestive heart failure and tubal ligation. CA2 algorithm is recommended for a patient with congestive heart failure and is undergoing tubal ligation. CA1 algorithm is shown between bypass surgery and cystoscopy. CA1 algorithm is recommended for a patient having had bypass surgery and is undergoing cystopcopy. DM/CA3 algorithms are shown between diabetes and diagnostic laparoscopy. DM and CA2 algorithms are recommended for a patient with diabetes and is undergoing diagnostic laparoscopy.

In evaluation table 100, testing algorithms PA, HTN, CA1, CA2, CA3, and DM are shown between patient medical conditions and surgical procedures. Again, it is recommended that a patient with one or more of the medical conditions, having one or more of the surgical procedures, should have the indicated testing algorithm(s) performed.

The grid in evaluation tables 98-100 has provided a significant information to the pre-surgical team in preparing patient 12 for surgery. Health care provider 14 has established one or more testing algorithms which relate medical conditions and surgical procedures. The testing algorithms are set forth in a decision-tree format and include evaluations, analysis, and one or more laboratory tests and physical tests, in a specific sequence and with specific testing conditions, e.g. pre-test eating and drinking instructions, physical activity during the test, etc. The testing algorithms recommend specific pre-surgery evaluations which the patient must have done to provide the surgical team with relevant information and reduce the risk associated with the procedure. The algorithms within the grid of evaluation tables 98-100 provide a convenient and comprehension pre-surgery evaluation of patient 12, under the guidelines and polices of health care provider 14.

Health care provider 14, in consultation with the heads of its various medical departments including internal medicine, surgery, anesthesia, and radiology, determines the necessary laboratory and physical testing which should be done for the given surgical procedure and known patient medical condition. The evaluation tables represent the best known information from research studies, recommendations from medical organizations and societies, government guidelines, experiences and judgment from staff physicians, and general consensus within health care provider 14. Health care provider 14 will consider the best interests of the patient, its available resources, its tolerance for risk, and the best recommendations and consultations of its medical staff and advisors.

Health care provider 14 compiles evaluation tables 90-100 by establishing the linkages or relationships between the axis of each table, as shown in FIGS. 6-10. The linkages are denoted by the marker(s) or other information placed within the grid relating the corresponding axis, as discussed above. For example, in evaluation table 90, the “X” in the grid between operative laparoscopy and CBC represents a linkage between the axis of the table. In evaluation table 98, the “PA” in the grid between D+C and emphysema represents a linkage between the axis of the table. In the case of evaluation table 90, the linkage supports the proposition that it is recommended that a patient undergoing operative laparoscopy have CBC preop testing. In the case of evaluation table 98, the linkage supports the proposition that it is recommended that a patient with emphysema who is undergoing D+C should follow a PA algorithm. The evaluation tables 90-100 are stored in the database on hard disk 34.

Evaluation tables 90-100 can be customized for each health care provider 14, i.e., the patient preop screening process is selectable and configurable by the respective medical institution. A first medical institution may have a first set of preop testing which it has adopted for each surgical procedure, while a second medical institution has a different set of preop testing which it follows for the same surgical procedures. The first medical institution may require an EKG for cystoscopy, while the second medical institution does not. Neither institution is right or wrong; they simply follow different standards and guidelines.

Moreover, evaluation tables 90-100 can be changed as needed. It is not uncommon for the testing recommendations from various sources to change as new studies and updated information becomes available. New and updated information is released on a regular basis. As new studies or recommendations are released, e.g., from the American Medical Association (AMA), which call for different preoperative testing for given surgical procedures and/or patient medical conditions, the guidelines are considered by health care provider 14. Once approved by health care provider 14, the evaluation tables 90-100 in the database on computer 30 are readily updated with the new guidelines. Having ready access to the latest in preoperative testing is convenient and useful to the physicians and surgeons involved in the procedure.

The evaluation tables 90-100 can be used in a variety of ways. Some health care providers will recommend and/or schedule laboratory and physical tests if indicated by either the surgical procedure, i.e., evaluation tables 90 and 92, or if indicated by patient medical condition, i.e., evaluation table 96. According to evaluation table 90, if patient 12 is scheduled for tubal ligation, then that patient receives CBC and type and cross 2 units preop testing. According to evaluation table 96, if patient 12 has hypertension, then that patient receives EKG preop testing.

Health care provider 14 will choose the order and preference given to each of the evaluation tables. The health care providers may give emphasis or deference to one or more of the evaluation tables, e.g., surgical procedure or patient medical condition, with consideration of the other evaluation tables, in formulating the algorithm for scheduling laboratory and physical tests. For example, if patient 12 is to undergo an exam under anesthesia and has liver disease, then additional laboratory tests, e.g., PT/PTT and liver function as per evaluation table 96, will be recommended and scheduled after consideration of the tests which may be indicated by evaluation table 90. Alternatively, if patient 12 needs to have liver resection and happens to have hypertension, then additional laboratory tests, e.g., CBC, liver function testing, and type and cross 6 units testing, will be recommended and scheduled after consideration of any tests indicated by evaluation table 96.

The evaluation tables 98 and 100 are particularly useful in relating surgical procedure to patient medical condition, i.e., which patient medical condition should be considered in light of the surgical procedure to be performed, and which surgical procedures should be considered in light of the patient's medical condition. In some cases, the testing recommended from evaluation tables 90-96 are performed before considering the algorithms in evaluation tables 98-100.

In some cases of relating surgical procedure and patient medical condition, more preoperative testing is recommended. In other cases, less preoperative testing is recommended after relating the surgical procedure and patient medical condition. Yet other health care providers will recommend laboratory and physical tests which are indicated by both the surgical procedure and the patient medical condition.

In any case, the use of one or more of the evaluation tables 90-100 given healthcare provider 14 the flexibility in formulating their own testing policy, using objective and consistent criteria, for recommending and scheduling laboratory and physical tests. The flexibility arises from the fact that health care provider 14 can define what linkages are assigned to each grid entry in the evaluation tables, and further that health care provider 14 can decide how the evaluation tables are used, individually and collectively. Health care provider 14 may publish guidelines instructing the medical staff on how to use evaluation tables 90-100, as described above. From the evaluation tables, the appropriate testing is recommended and scheduled.

Returning to FIG. 1, block 18 illustrates the above-described process of utilizing the evaluation tables 90-100 to determine which preoperative laboratory and physical test(s) should be preformed prior to surgery. The medical staff has access to the evaluation tables 90-100 as shown by the link between block 18 and health care provider 14. Computer 30 generates worksheets or reports, from evaluation tables 90-100, along with physician and patient-provided information, automatically to the pre-surgical medical staff. The reports derived from evaluation tables 90-100 will indicate which laboratory and physical testing are recommended and should be done before surgery, based on the patient's medical condition or health history and evasiveness of the surgical procedure. The actual report will typically include only the procedure(s) from the evaluation tables which the patient is to have performed and the medical conditions attributed to the patient. Evaluation tables 90-100 provide a reliable and consistent means of ordering lab test(s) over all types of procedures, conditions, and situations. The medical staff evaluates the reports, calls the patient to confirm any information and arrange a time to come in for the testing, and then schedules the necessary laboratory and physical testing. The follow-up session with patient 12 after preop evaluation and analysis provides the opportunity to verify questionnaire, answer any patient questions, confirm the physicians and surgeons involved, review the surgical procedures to be performed, and inform the patient as to the reasons for the preop testing.

Patient 12 undergoes the indicated and recommended preoperative testing in block 19 of FIG. 1. The test results are recorded in the patient database on hard disk 34 by the testing departments. Health care provider 14 has access to the test results as shown by the link to block 19. On the day of surgery, all necessary patient information is recorded and preoperative testing completed. The occurrence of surgical procedure cancellation is reduced by the use of the patient questionnaire and determination of recommended preoperative testing by use of the evaluation tables 90-100.

Another advantage of health care screening system 10 is the standardization of laboratory and physical testing and real-time availability of most up-to-date information and guidelines. It is not uncommon for one surgeon performing a given procedure to order one group of tests and another surgeon performing the same procedure on a similar type of patient to order a different group of tests. The discrepancy arises from the surgeons having different professional perspectives and experiences. Sometimes there is a lack of information, or just not having access to the latest best practices and guidelines. Health care screening system 10 gives the medical staff access to the current best medical practices and guidelines as adopted by health care provider 14. If preop testing guidelines change due to new studies or recommendations from overseeing medical associations, then the person(s) or committee at health care provider 14 responsible for maintaining evaluation tables 90-100 can decide how to incorporate the new information in the evaluation tables. The new guidelines are updated on computer 30 and immediate become available to the medical staff. The new guidelines are disseminated very quickly and efficiently. Everyone is working from a common set of guidelines, which represents the best known information and is in-line with the hospital policy as determined by the collective knowledge and experience of its medical staff.

Health care screening system 10 does not usurp the internist, surgeon, or anesthesiologist in determining best interest of patient 12. The doctor can always order additional tests if indicated by their own judgment and knowledge of patient 12 and prior experiences. Health care screening system 10 represents recommended patient evaluation and testing which should be performed preoperatively. Most physicians will appreciate the evaluation tables 90-100 as a useful tool in keeping up with the ever-changing best testing practices.

Yet another advantage of health care screening system 10 comes from printed worksheet or report, which is given to the medical staff and patient 12 before surgery. Additionally, preop instructions and directions that include areas such as changes to medication, diet, and physical activity levels and directions to the surgical center are printed for the patient. The preop instructions may take patient 12 off blood-thinning medication for some period of time, or recommend levels of insulin on day of surgery for diabetic patients. The preop instructions may call for beta-blocker for heart patients, Cox-2 inhibitors for procedures involving significant postoperative pain, thromboembolic protocol to reduce postoperative clotting in the extremities, or refer patient 12 to another specialist or their regular doctor. The reports and instructions to patient 12 can be printed in multiple languages, e.g., the patient's and physician's native language, which increases the coherence of the report by all concerned and increases the chances that the patient instructions will be understood and followed.

In block 20 of FIG. 1, patient 12 undergoes the surgical procedure. The patient has used a convenient software program to provide an accurate and up-to-date self-evaluation of his or her health history and medical condition. The patient's medical condition, as well as information provided by health care provider 14, are analyzed in view of evaluation tables 90-100 to determined the recommend preoperative testing, which is performed prior to surgery. On the day of surgery, the necessary preop testing should have been performed in accordance with the policies and guidelines of health care provider 14. Accordingly, the incidence of delays or cancellations in the use of the operating room is reduced by the use of evaluation tables 90-100.

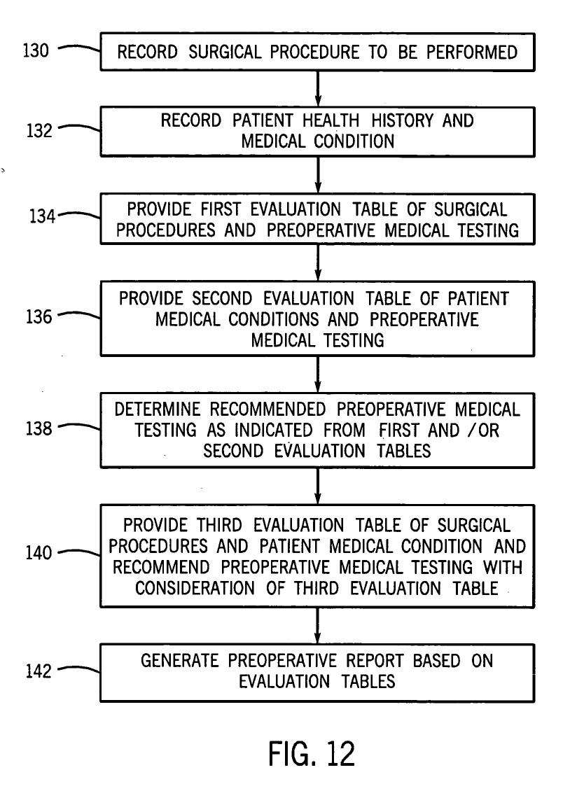

The process of evaluating and recommending preoperative medical testing is shown in FIG. 12. Step 130 records a surgical procedure to be performed. The surgical procedure to be performed is provided by a physician. Step 132 records patient medical condition and health history. The patient health history and medical condition is obtained through patient responses to a questionnaire. Step 134 provides a first evaluation table of surgical procedures and corresponding preoperative medical tests. Step 136 provides a second evaluation table of patient medical condition and corresponding preoperative medical tests. The preoperative medical tests indicated by the surgical procedure and patient medical condition are maintained in a database, which is updated with changes to preoperative medical testing guidelines. The preoperative medical tests indicated by the surgical procedure and patient medical condition are configurable for each medical institution. Step 138 recommends preoperative medical testing as indicated from the first and/or second evaluation tables. The preoperative medical test(s) may be determined from the first evaluation table with consideration of the second evaluation table. Alternatively, the preoperative medical tests are determined from the second evaluation table with consideration of the first evaluation table. Step 140 provides a third evaluation table of surgical procedures and corresponding patient medical condition, and recommends preoperative medical testing with consideration of the third evaluation table. Step 142 generates a first preoperative report for medical staff and a second preoperative report for patients based on the first and/or second evaluation tables.

Additional features for health care screening system 10 include providing audio questions during the patient questionnaire session and voice recognition to record the answers. Patient 12 listens to the questions and speaks into a microphone to provide the answers to the questionnaire. Additionally, computers 42-44 and kiosk 45 can be out-fitted with touch screens for data entry.

While one or more embodiments of the present invention have been illustrated in detail, the skilled artisan will appreciate that modifications and adaptations to those embodiments may be made without departing from the scope of the present invention as set forth in the following claims.

1. A method of determining recommended preoperative medical testing, comprising:
recording patient medical condition;
recording a surgical procedure to be performed;
providing a first evaluation table of surgical procedures and corresponding preoperative medical testing;
providing a second evaluation table of patient medical condition and corresponding preoperative medical testing; and
determining the recommended preoperative medical testing as indicated from the first and second evaluation tables.

2. The method of claim 1, wherein the preoperative medical testing is determined from the first evaluation table with consideration of the second evaluation table.

3. The method of claim 1, wherein the preoperative medical testing is determined from the second evaluation table with consideration of the first evaluation table.

4. The method of claim 1, further including the steps of:
providing a third evaluation table of surgical procedures and corresponding patient medical condition; and
determining recommended preoperative medical testing with consideration of the third evaluation table.

5. The method of claim 1, wherein the patient medical condition is obtained through patient responses to a questionnaire.

6. The method of claim 1, wherein the surgical procedure to be performed is provided by a physician.

7. The method of claim 1, wherein the preoperative medical testing indicated by the surgical procedure and patient medical condition are maintained in a database, which is updated with changes to preoperative medical testing guidelines.

8. The method of claim 1, wherein the preoperative medical testing indicated by the surgical procedure and patient medical condition are configurable for each medical institution.

9. The method of claim 1, further including the step of generating a first preoperative report for medical staff and a second preoperative report for patients based on the first and second evaluation tables.

10. A method of providing for determining a preoperative medical testing, comprising:
providing a first evaluation table of surgical procedures and corresponding preoperative medical testing;
providing a second evaluation table of patient medical condition and corresponding preoperative medical testing; and
determining preoperative medical testing as indicated by the first or second evaluation tables.

11. The method of claim 10, wherein the preoperative medical testing is determined from the first evaluation table with consideration of the second evaluation table.

12. The method of claim 10, wherein the preoperative medical testing is determined from the second evaluation table with consideration of the first evaluation table.

13. The method of claim 10, further including the steps of:
providing a third evaluation table of surgical procedures and corresponding patient medical condition; and
determining recommended preoperative medical testing with consideration of the third evaluation table.

14. The method of claim 10, wherein the patient medical condition is obtained through patient responses to a questionnaire.

15. The method of claim 10, wherein the surgical procedure to be performed is provided by a physician.

16. The method of claim 10, wherein the preoperative medical testing as indicated by the surgical procedure and patient medical condition are maintained in a database, which is updated with changes to preoperative medical testing guidelines.

17. The method of claim 10, wherein the preoperative medical testing indicated by the surgical procedure and patient medical condition are configurable for each medical institution.

18. The method of claim 10, further including the step of generating a first preoperative report for medical staff and a second preoperative report for the patient based on the first or second evaluation tables.

19. The method of claim 10, wherein the second preoperative report is created in one of multi-lingual instructions and directions.

20. The method of claim 10, wherein the preoperative medical testing is determined based on a testing algorithm.

21. A method of evaluating preoperative medical care, comprising:
providing a record of surgical procedure and patient medical condition; and
providing for preoperative medical testing with consideration of the surgical procedure or patient medical condition.

22. The method of claim 21, further including:
providing a first evaluation table of surgical procedures and corresponding preoperative medical testing;
providing a second evaluation table of patient medical condition and corresponding preoperative medical testing; and
determining recommended preoperative medical testing as indicated by the first or second evaluation tables.

23. The method of claim 22, wherein the preoperative medical testing is determined from the first evaluation table with consideration of the second evaluation table.

24. The method of claim 22, wherein the preoperative medical testing is determined from the second evaluation table with consideration of the first evaluation table.

25. The method of claim 22, further including the steps of:
providing a third evaluation table of surgical procedures and corresponding patient medical condition; and
determining recommended of preoperative medical testing with consideration of the third evaluation table.

26. The method of claim 22, wherein the preoperative medical testing as indicated by the surgical procedure and patient medical condition are maintained in a database, which is updated with changes to preoperative medical testing guidelines.

27. The method of claim 22, wherein the preoperative medical testing indicated by the surgical procedure and patient medical condition are configurable for each medical institution.

28. The method of claim 22, further including the step of generating a first preoperative report for medical staff and a second preoperative report for the patient based on the first or second evaluation tables.

29. The method of claim 28, wherein the second preoperative report is created in one of multi-lingual instructions and directions.

30. The method of claim 21, wherein the preoperative medical testing is determined based on a testing algorithm.

31. A method of providing for preoperative medical care, comprising:
relating surgical procedure to preoperative medical testing;
relating patient medical condition to preoperative medical testing; and
selecting preoperative medical testing based on the surgical procedure or patient medical condition.

32. The method of claim 31, further including:
providing a first evaluation table of surgical procedures and corresponding preoperative medical testing; and
providing a second evaluation table of patient medical condition and corresponding preoperative medical testing.

33. The method of claim 32, wherein the preoperative medical testing is determined from the first evaluation table with consideration of the second evaluation table.

34. The method of claim 32, wherein the preoperative medical testing is determined from the second evaluation table with consideration of the first evaluation table.

35. The method of claim 32, further including the steps of relating surgical procedures to patient medical condition.

36. The method of claim 32, wherein the preoperative medical testing is determined based on a testing algorithm.

37. A system of providing for preoperative medical care, comprising:
means for relating surgical procedure to preoperative medical testing;
means for relating patient medical condition to preoperative medical testing; and
means for selecting preoperative medical testing based on the surgical procedure or patient medical condition.

38. The system of claim 37, further including:
means for providing a first evaluation table of surgical procedures and corresponding preoperative medical testing;
means for providing a second evaluation table of patient medical condition and corresponding preoperative medical testing; and
means for determining recommended preoperative medical testing as indicated by the first or second evaluation table.

39. The system of claim 38, further including the steps of:
means for providing a third evaluation table of surgical procedures and corresponding patient medical condition; and
means for determining recommended preoperative medical testing with consideration of the third evaluation table.

40. A computer readable storage medium contain a computer program, comprising:
computer executable instructions for relating surgical procedure to preoperative medical testing;
computer executable instructions for relating patient medical condition to preoperative medical testing; and
computer executable instructions for selecting preoperative medical testing based on the surgical procedure or patient medical condition.

41. The computer readable storage medium of claim 40, wherein the computer program further includes computer executable instructions for relating surgical procedures and corresponding patient medical condition.
